(19) United States
(12) Patent Application Publication
(10) Pub. No.: US 2020/0293695 A1
(43) Pub. Date: Sep. 17, 2020

(54) RIGHT DETERMINATION SYSTEM, SECURE DEVICE, DETERMINATION DEVICE, RIGHT MANAGEMENT METHOD, AND RIGHT DETERMINATION PROGRAM

(71) Applicant: NEC CORPORATION, Tokyo (JP)

(72) Inventors: Ryo HAMAMOTO, Minato-ku, Tokyo (JP); Takayuki SASAKI, Minato-ku, Tokyo (JP)

(73) Assignee: NEC Corporation, Tokyo (JP)

(21) Appl. No.: 16/630,056

(22) PCT Filed: Jul. 12, 2017
(86) PCT No.: PCT/JP2017/025414

§ 371 Date: Jan. 10, 2020

(51) Int. Cl. G06F 21/78; G06F 21/74; G06F 21/62; G06F 21/86; G06F 12/14

(52) U.S. Cl. CPC G06F 21/78; G06F 21/74; G06F 12/1416; G06F 21/86; G06F 21/6209

(57) ABSTRACT

A device 81 includes a memory space having a secure space. A determination device 82 is disposed in the secure space and determines a right in a region in the secure space. A policy storage unit 83 is disposed in the secure space and stores a policy having defined therein at least one of an access right to the region and an execution right of a function disposed in the region. Access to the secure space and execution of the function in the secure space are performed via the determination device 82, and the determination device 82 controls the access to and the execution in the secure space on the basis of the policy.

### TECHNICAL FIELD

The present invention relates to a right determination system, a secure device, a determination device, a right management method, and a right determination program that determine a right in a secure space to perform control.

### BACKGROUND ART

With the widespread use of Internet of Things (IoT), an increasing number of embedded devices are connected to networks. This makes the measures against illegal acts such as tampering with device information more and more important.

Various methods for preventing such illegal acts are known. At the hardware level, a security measure according to the trusted execution environment (TEE), for example, has been performed. As another method, a memory space prohibiting direct access from a user is established, and confidential information and security processing are implemented in the secure space. Specific examples of such a method include Intel SGX (software guard eXtentions) and ARM TrustZone. Here, Intel, ARM, and TrustZone are registered trademarks.

Patent Literature (PTL) 1 describes a method of prohibiting an unauthorized person's act of accessing a program of a microprocessor having confidential information. In the method described in PTL 1, a main storage memory is divided into a secure region and a non-secure region, and the secure region is subdivided into a secure common region, a secure boot region, a secure application instruction region, etc. In accordance with the definitions of the subdivided regions, read and write operations as usual are allowed with respect to the accesses with rights; otherwise, the access control is performed to cause the write and read operations to fail.

PTL 2 describes a data processing apparatus that uses different secure domains. PTL 2 describes that programming code is executed in each of a least secure domain, a secure domain, and a most secure domain, and that different levels of secure data may be accessed depending on the domain.

### CITATION LIST

### Patent Literature

PTL 1: Japanese Patent Application Laid-Open No. 2010-134572

PTL 2: Japanese Translation of PCT International Application Publication No. 2015-534689

### SUMMARY OF INVENTION

### Technical Problem

Generally, only a few kinds of rights of lower levels are set in a secure space, in order to prevent a malicious process from operating when such a process is implemented in the secure space. For example, in TEE mentioned above, a function implemented in the secure space has only one kind of right for the sake of safety. In SGX, the lowest right, Ring 3, is imparted to the secure space.

When considering designing of a general device, the safety is taken more seriously than the degree of freedom, so the degree of freedom in device designing decreases.

That is, as there is a tradeoff between the degree of freedom in designing and the safety, any function requiring a certain degree of right is implemented outside the secure space.

For example, in the case of general device designing, the device driver that causes input devices such as a sensor and a keyboard and output devices such as an actuator and a display to work is implemented outside the secure space, because the device driver cannot be utilized directly in the secure space. However, outside the secure space where security is low, the device driver can be said to be exposed to threat of tampering. If the driver is tampered with, the input/output devices in the device will not operate properly.

The method described in PTL 1 focuses only on the read and write operations in the regions. There is no consideration on how to enable secure operations of the device.

The method described in PTL 2 realizes access control in accordance with the presence or absence of an extended instruction called a guard instruction. However, with such a method performing control by extending instructions, the program will have to be modified, and the degree of freedom in designing will also remain low.

An object of the present invention is thus to provide a right determination system, a secure device, a determination device, a right management method, and a right determination program that are capable of improving the degree of freedom in designing, while maintaining the safety in the secure space, to thereby establish a safe channel (path) between the input/output device and the secure space.

### Solution to Problem

A right determination system according to the present invention includes: a device including a memory space having a secure space; a determination device disposed in the secure space and configured to determine a right in a region in the secure space; and a policy storage unit disposed in the secure space and storing a policy having defined therein at least one of an access right to the region and an execution right of a function disposed in the region; wherein access to the secure space and execution of the function in the secure space are performed via the determination device, and the determination device controls the access to and the execution in the secure space on the basis of the policy.

A secure device according to the present invention is a secure device including a memory space having a secure space, and includes: a determination device disposed in the secure space and configured to determine a right in a region in the secure space; and a policy storage unit disposed in the secure space and storing a policy having defined therein at least one of an access right to the region and an execution right of a function disposed in the region; wherein access to the secure space and execution of the function in the secure space are performed via the determination device, and the determination device controls the access to and the execution in the secure space on the basis of the policy.

A determination device according to the present invention is a determination device disposed in a secure space in a memory space included in a device, wherein access to the secure space and execution of a function in the secure space are performed via the determination device, and the determination device determines a right in a region in the secure space on the basis of a policy disposed in the secure space and having defined therein at least one of an access right to the region in the secure space and an execution right of a function disposed in the region, and controls the access to and the execution in the secure space.

A right management method according to the present invention is a right management method for a secure device including a memory space having a secure space, wherein a determination device disposed in the secure space and configured to determine a right in a region in the secure space controls access to and execution in the secure space on the basis of a policy disposed in the secure space and having defined therein at least one of an access right to the region in the secure space and an execution right of a function disposed in the region, and the access to the secure space and the execution of the function in the secure space are performed via the determination device.

A right determination program according to the present invention is a right determination program applied to a computer disposed in a secure space in a memory space included in a device, wherein access to the secure space and execution of a function in the secure space are performed via the computer, and the program causes the computer to perform: processing of determining a right in a region in the secure space on the basis of a policy disposed in the secure space and having defined therein at least one of an access right to the region in the secure space and an execution right of a function disposed in the region; and processing of controlling the access to and the execution in the secure space.

### Advantageous Effects of Invention

The present invention makes it possible to establish a safe channel (path) between the input/output device and the secure space by improving the degree of freedom in designing while maintaining the safety in the secure space.

### BRIEF DESCRIPTION OF DRAWINGS

FIG. 1 is a block diagram showing an embodiment of a right determination system according to the present invention.

FIG. 2 is a diagram illustrating an exemplary device.

FIG. 3 is a diagram illustrating an exemplary memory space in the device.

FIG. 4 is a diagram illustrating an exemplary policy having rights defined for respective regions.

FIG. 5 is a diagram illustrating another exemplary policy defined.

FIG. 6 is a diagram illustrating an exemplary policy having rights defined for respective functions.

FIG. 7 is a diagram illustrating another exemplary policy defined.

FIG. 8 is a flowchart illustrating an exemplary operation of the right determination system.

FIG. 9 is a block diagram showing an overview of a right determination system according to the present invention.

FIG. 10 is a block diagram showing an overview of a secure device according to the present invention.

FIG. 11 is a block diagram showing an overview of a determination device according to the present invention.

### DESCRIPTION OF EMBODIMENT

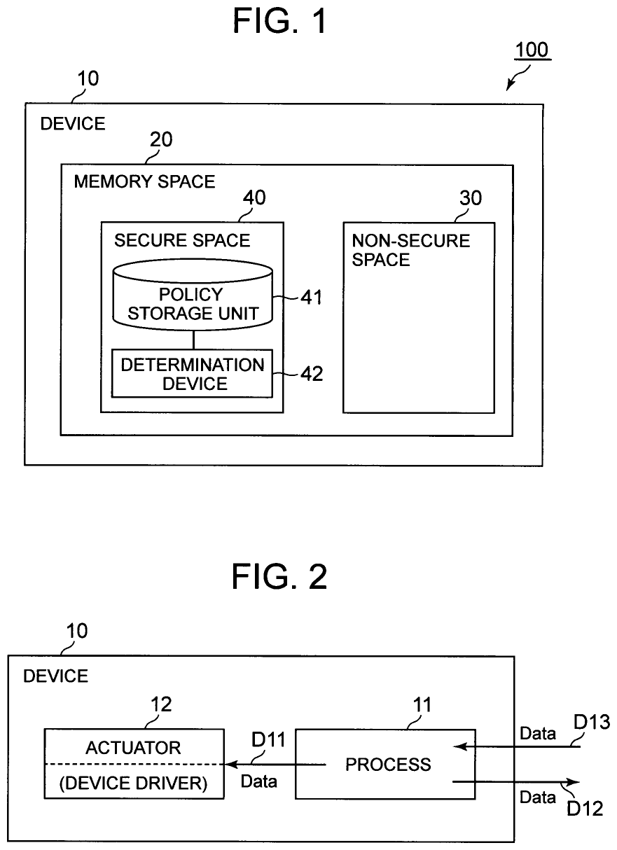

An embodiment of the present invention will be described below with reference to the drawings. FIG. 1 is a block diagram showing an embodiment of a right determination system according to the present invention. The right determination system 100 of the present embodiment is realized by a device 10 including a memory space 20. It should be noted that the device 10 realizing the right determination system 100 of the present embodiment can be called a secure device, because the device 10 securely manages the memory space 20 by a function which will be described later.

The memory space 20 has a non-secure space 30 and a secure space 40. The non-secure space 30 is a freely accessible memory space where there are no particular restrictions on the access from the outside and execution of functions. On the other hand, the secure space 40 is a memory space where certain restrictions are placed on the access from the outside and the execution of the functions. In the present embodiment, the secure space 40 is a memory space accessible only via a determination device 42 which will be described later.

In the example shown in FIG. 1, there are one non-secure space 30 and one secure space 40. However, each of the non-secure space 30 and the secure space 40 does not necessarily have to be realized by one space, and may be realized by two or more spaces.

Further, in the present embodiment, it is assumed that the secure space 40 is divided into one or more regions (Enclaves). In the present embodiment, a right is set for each region. In other words, information is set that indicates what can be executed in respective regions. The region may also be referred to as an address in the memory space or a subspace in the memory space.

The right determination system 100 includes a policy storage unit 41 and a determination device 42. The policy storage unit 41 and the determination device 42 are both disposed in the secure space 40.

FIG. 2 is a diagram illustrating an example of the device 10 of the present embodiment. The device 10 assumed in the present embodiment is a (single) IoT device, which has installed therein a hardware-level security function having a tamper resistance. The device 10 includes a process 11 which generates data D11, and an input/output device (by way of example in FIG. 2, actuator) 12 which operates on the basis of the data D11 generated by the process 11 or which is connected to the process 11.

The data D11 generated by the process 11 includes, not only simple numerical values and character strings, but also instruction commands to the input/output device 12. The process 11 is, for example, a CPU of a computer that operates in accordance with a program or code.

The input/output device 12 is a portion that runs in accordance with operations, which is, for example, a motor that is driven under the control of a device driver. The device 10 may include more than one process 11 and more than one input/output device 12. In the present embodiment, data D12 transmitted from the device 10 to the outside and data D13 transmitted into the device 10 from the outside are not the target of control.

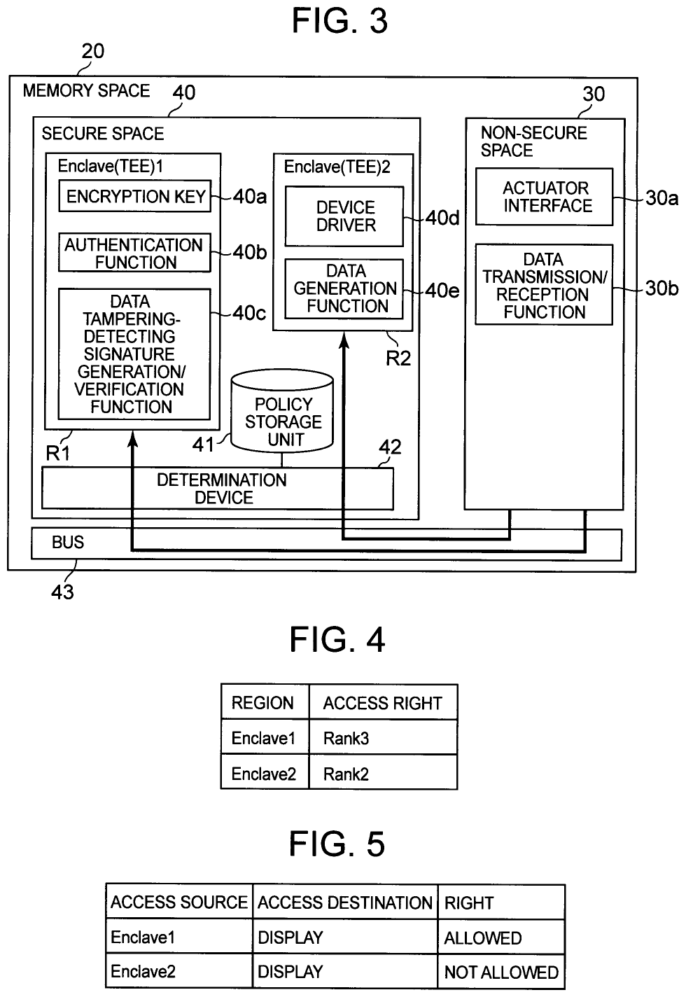

FIG. 3 is a diagram illustrating an example of the memory space 20 of the device 10. The memory space 20 illustrated in FIG. 2 has a non-secure space 30 and a secure space 40 realized by TEE. The non-secure space 30 illustrated in FIG. 2 has disposed therein a code or program realizing an input/output device interface (by way of example in FIG. 3, actuator interface) 30a (hereinafter, simply referred to as “actuator interface”) that transmits and receives information to and from the input/output device 20, and a code or program realizing a data transmission/reception function 30b (hereinafter, simply referred to as “data transmission/reception function”) that performs transmission and reception of data between the secure space and the non-secure space. In the example shown in FIG. 3, no particular execution restrictions are placed on the actuator interface and the data transmission/reception function.

On the other hand, the secure space 40 illustrated in FIG. 3 has two regions R1 and R2 (Enclave 1 and Enclave 2). It is assumed that a low-level right is set to the region R1 and a medium-level right is set to the region R2. In the example shown in FIG. 2, the region R1 has disposed therein an encryption key 40a , a code or program realizing an authentication function 40b (hereinafter, simply referred to as “authentication function 40b”), and a code or program realizing a data tampering-detecting signature generation/verification function 40c (hereinafter, simply referred to as “data tampering-detecting signature generation/verification function 40c”).

Similarly, the region R2 has disposed therein a device driver 40d for the input/output device (the actuator by way of example in FIG. 3), and a code or program realizing a data generation function 40e (hereinafter, simply referred to as “data generation function 40e”). In the description of the present embodiment, “disposing a function in a region” specifically means that the code or program for realizing the function is held in the region.

The policy storage unit 41 stores a policy in which access rights to the regions in the secure space 40 are defined. The policy storage unit 41 further stores a policy in which execution rights of the functions disposed in the regions in the secure space 40 are defined. It should be noted that the policy storage unit 41 may store either one or both of the access rights and the execution rights.

Specifically, in the policy, a graded access right is defined for each of the regions in the secure space. FIG. 4 is a diagram illustrating an exemplary policy in which rights are defined for respective regions. In the example illustrated in FIG. 4, two regions have different access rights set therefor. Specifically, in the example illustrated in FIG. 4, an access right of Rank 3 is set for the region R1 (Enclave 1), and an access right of Rank 2 is set for the region R2 (Enclave 2). It should be noted that the policy may have defined therein an access right rendering a region “Default”, so as to set access rights for regions other than those explicitly defined. What can be executed is predetermined in accordance with the rank of the access right.

FIG. 5 is a diagram illustrating another exemplary policy defined. Besides the settings by ranks, a policy may be defined, as illustrated in FIG. 5, such that a certain Enclave allows or disallows access to a function of a certain device (for example, a display device). In this case as well, the policy may be defined to leave a region as “Default”.

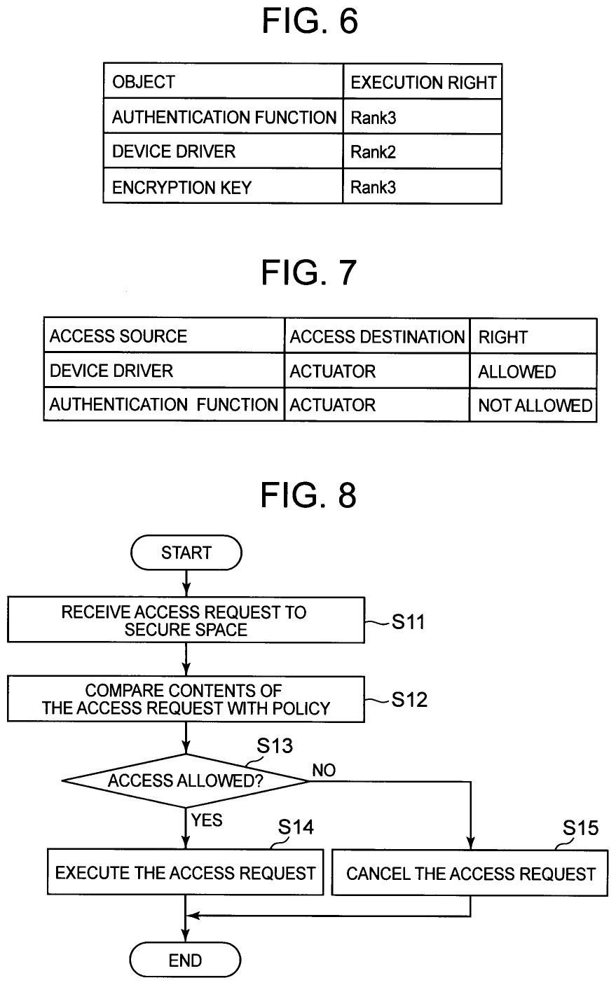

Further, in the policy, a graded execution right is defined for each function disposed in a region. FIG. 6 is a diagram illustrating an exemplary policy in which rights are defined for respective functions. In the example illustrated in FIG. 6, different execution rights are set for objects included in regions. Specifically, in the example illustrated in FIG. 6, an execution right of Rank 3 is set for the authentication function, an execution right of Rank 2 is set for the device driver, and an execution right of Rank 3 is set for the encryption key. For example, it is assumed that with the right of Rank 3, it is not possible to execute the device driver directly from within the Enclave. In contrast, in the present embodiment, the right of the device driver is set to Rank 2, thereby enabling execution of the device driver even from within the Enclave. It should be noted that the policy may have defined therein an execution right rendering an object “Default”, so as to set execution rights for functions other than those explicitly defined.

FIG. 7 is a diagram illustrating another exemplary policy defined. Besides the settings by ranks, a policy may be defined, as illustrated in FIG. 7, to allow or disallow a function of a certain device to access a function of another device (for example, an actuator). In this case as well, the policy may be defined to leave a function of an access source as “Default”.

The determination device 42 determines a right in each region in the secure space. As explained above, the determination device 42 is disposed in the secure space 40. In the present embodiment, access to the secure space 40 and execution of a function in the secure space 40 are performed via the determination device 42. In the example illustrated in FIG. 3, for example, a designation transmitted from the non-secure space 30 via a bus 43 is received in the determination device 42. That is, access from the non-secure space 30 (memory space outside the secure space 40) to the secure space 40 is always made via the determination device 42.

The determination device 42 controls access to and execution in the secure space 40 on the basis of the policy stored in the policy storage unit 41. For example, when the determination device 42 determines that there is no access or execution right with respect to the secure space 40, the determination device 42 may cancel the access or execution request, or reply to the request source to the effect that there is no such right.

Further, the determination device 42 performs, for example, reading from a region in the secure space 40, writing to a region in the secure space 40, or execution of a code or program stored in the region, in accordance with the right indicated by the determination result based on the policy.

It should be noted that, for the determination device 42 to control the access to and/or the execution in the secure space 40, the determination device 42 (as well as the policy storage unit 41) has a highest right set in the secure space. For example, when the secure space is realized in TEE, the determination device 42 (as well as the policy storage unit 41) has a highest right set from among the rights that are set in the TEE.

The determination device 42 may be realized as an extension of a CPU, for example. That is, the determination device 42 may be realized by the CPU of the computer that operates in accordance with the program (right determination program). For example, with the program stored in the policy storage unit 41, the CPU may read the program and operate as the determination device 42 in accordance with the program.

Further, the determination device 42 may be realized by dedicated hardware, or may be implemented as software on the TEE dedicated to the determination device 42. When the memory space 20 has a plurality of secure spaces 40, the determination device 42 may be disposed in any one of the secure spaces 40. Alternatively, the determination device 42 and the policy storage unit 41 may be disposed corresponding to the respective secure spaces.

The policy storage unit 41 is realized by a storage (not shown) included in the device 10 or a random access memory (RAM) in the device 10. Here, the RAM may be a dedicated RAM, or may be a part of a commonly used RAM made available for storing a policy.

An operation of the right determination system 100 of the present embodiment will now be described. FIG. 8 is a flowchart illustrating an exemplary operation of the right determination system 100 of the present embodiment. The determination device 42 receives an access request to the secure space 40 (step S11). The determination device 42 compares the contents of the access request with a policy (step S12) to determine the right in the secure space.

When it is determined that the access is allowed (or, when it is determined that there is such a right) (Yes in step S13), the determination device 42 executes the access request (step S14). When it is determined that the access is not allowed (or, when it is determined that there is no such right) (No in step S13), the determination device 42 cancels the access request (step S15). In step S15, the determination device 42 may notify the user that the access is not allowed.

As described above, in the present embodiment, access to the secure space 40 and execution of a function in the secure space 40 are performed via the determination device 42, and the determination device 42 is also disposed in the secure space 40. The determination device 42 determines a right in a region in the secure space 40 on the basis of a policy having defined therein at least one of an access right to the region in the secure space 40 and an execution right of a function disposed in the region, and controls the access to and the execution in the secure space.

This improves the degree of freedom in designing, while maintaining the safety in the secure space. That is, in the present embodiment, the rights in the secure space can be set individually and in stages for respective regions in the secure space, so it is possible to solve the tradeoff between the safety and the degree of freedom in designing, and thus to establish a safe channel between the input/output device and the secure space.

For example, upgrading the right in the secure space where the device driver is implemented enables direct access even within the secure space. Further, disposing the device driver in the secure space makes it possible to prevent the tampering with the device driver, thereby enabling a proper operation of the input/output device (actuator) as illustrated in FIG. 2. That is, the process 11 illustrated in FIG. 2 up to the actual operation of the input/output device (actuator) 12 can be implemented more flexibly and securely, and a safe channel can be established between the input/output device and the secure space.

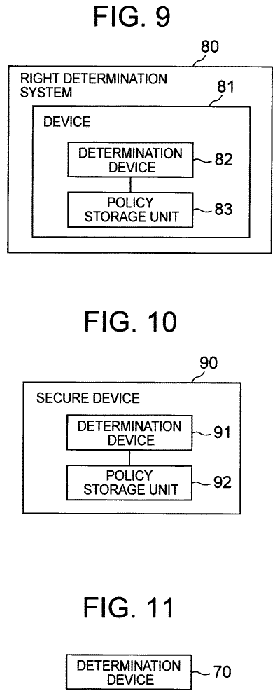

A description will now be given of an overview of the present invention. FIG. 9 is a block diagram showing an overview of a right determination system according to the present invention. The right determination system 80 according to the present invention includes: a device 81 (for example, the device 10) including a memory space (for example, the memory space 20) having a secure space (for example, the secure space 40); a determination device 82 (for example, the determination device 42) that is disposed in the secure space and configured to determine a right in a region in the secure space; and a policy storage unit 83 (for example, the policy storage unit 41) that is disposed in the secure space and stores a policy having defined therein at least one of an access right to the region and an execution right of a function disposed in the region.

Access to the secure space and execution of the function in the secure space are performed via the determination device 82, and the determination device 82 controls the access to and the execution in the secure space on the basis of the policy.

Such a configuration makes it possible to improve the degree of freedom in designing, while maintaining the safety in the secure space, whereby a safe channel (path) can be established between the input/output device and the secure space.

Further, the policy storage unit 83 may store the policy having defined therein at least one of graded access rights for respective regions in the secure space and graded execution rights for respective functions disposed in the regions.

Specifically, the secure space has a tamper resistance, and the determination device 82 has a highest right set in the secure space having the tamper resistance.

Further, the determination device 82 may perform, in accordance with the right indicated by a determination result, reading from a region in the secure space, writing to the region, or execution of a code or program held in the region.

Further, the memory space may have a plurality of secure spaces. Then, the determination device 42 may be disposed in any one of the plurality of secure spaces.

FIG. 10 is a block diagram showing an overview of a secure device according to the present invention. The secure device 90 according to the present invention is a secure device (for example, the device 10) including a memory space (for example, the memory space 20) having a secure space (for example, the secure space 40), and includes: a determination device 91 (for example, the determination device 42) that is disposed in the secure space and configured to determine a right in a region in the secure space; and a policy storage unit 92 (for example, the policy storage unit 41) that is disposed in the secure space and stores a policy having defined therein at least one of an access right to the region and an execution right of a function disposed in the region.

Access to the secure space and execution of the function in the secure space are performed via the determination device 91, and the determination device 91 controls the access to and the execution in the secure space on the basis of the policy.

With such a configuration as well, it is possible to improve the degree of freedom in designing, while maintaining the safety in the secure space.

Further, the policy storage unit 92 may store the policy having defined therein at least one of graded access rights for respective regions in the secure space and graded execution rights for respective functions disposed in the regions.

FIG. 11 is a block diagram showing an overview of a determination device according to the present invention. The determination device 70 according to the present invention is a determination device (for example, the determination device 42) that is disposed in a secure space (for example, the secure space 40) in a memory space (for example, the memory space 20) included in a device (for example, the device 10), wherein access to the secure space and execution of a function in the secure space are performed via the determination device 70.

The determination device 70 determines a right in a region in the secure space on the basis of a policy disposed in the secure space and having defined therein at least one of an access right to the region in the secure space and an execution right of a function disposed in the region, and controls the access to and the execution in the secure space.

With such a configuration as well, it is possible to improve the degree of freedom in designing, while maintaining the safety in the secure space.

A part or a whole of the above embodiment may also be described as, but not limited to, the following supplementary notes.

(Supplementary note 1) A right determination system comprising: a device including a memory space having a secure space; a determination device disposed in the secure space and configured to determine a right in a region in the secure space; and a policy storage unit disposed in the secure space and storing a policy having defined therein at least one of an access right to the region and an execution right of a function disposed in the region; wherein access to the secure space and execution of the function in the secure space are performed via the determination device, and the determination device controls the access to and the execution in the secure space on the basis of the policy.

(Supplementary note 2) The right determination system according to supplementary note 1, wherein the policy storage unit stores the policy having defined therein at least one of graded access rights for respective regions in the secure space and graded execution rights for respective functions disposed in the regions.

(Supplementary note 3) The right determination system according to supplementary note 1 or 2, wherein the secure space has a tamper resistance, and the determination device has a highest right set in the secure space having the tamper resistance.

(Supplementary note 4) The right determination system according to any one of supplementary notes 1 to 3, wherein the determination device performs, in accordance with the right indicated by a determination result, reading from a region in the secure space, writing to the region, or execution of a code or program held in the region.

(Supplementary note 5) The right determination system according to any one of supplementary notes 1 to 4, wherein the memory space has a plurality of secure spaces, and the determination device is disposed in any one of the plurality of secure spaces.

(Supplementary note 6) A secure device including a memory space having a secure space, the secure device comprising: a determination device disposed in the secure space and configured to determine a right in a region in the secure space; and a policy storage unit disposed in the secure space and storing a policy having defined therein at least one of an access right to the region and an execution right of a function disposed in the region; wherein access to the secure space and execution of the function in the secure space are performed via the determination device, and the determination device controls the access to and the execution in the secure space on the basis of the policy.

(Supplementary note 7) The secure device according to supplementary note 6, wherein the policy storage unit stores the policy having defined therein at least one of graded access rights for respective regions in the secure space and graded execution rights for respective functions disposed in the regions.

(Supplementary note 8) A determination device disposed in a secure space in a memory space included in a device, wherein access to the secure space and execution of a function in the secure space are performed via the determination device, and the determination device determines a right in a region in the secure space on the basis of a policy disposed in the secure space and having defined therein at least one of an access right to the region in the secure space and an execution right of a function disposed in the region, and controls the access to and the execution in the secure space.

(Supplementary note 9) The determination device according to supplementary note 8, wherein the policy has defined therein at least one of graded access rights for respective regions in the secure space and graded execution rights for respective functions disposed in the regions.

(Supplementary note 10) A right management method for a device including a memory space having a secure space, the method comprising: controlling access to and execution in the secure space by a determination device on the basis of a policy, the determination device being disposed in the secure space and configured to determine a right in a region in the secure space, the policy being disposed in the secure space and having defined therein at least one of an access right to the region in the secure space and an execution right of a function disposed in the region, wherein the access to the secure space and the execution of the function in the secure space are performed via the determination device.

(Supplementary note 11) The right management method according to supplementary note 10, wherein the policy has defined therein at least one of graded access rights for respective regions in the secure space and graded execution rights for respective functions disposed in the regions.

(Supplementary note 12) A right determination program applied to a computer disposed in a secure space in a memory space included in a device, access to the secure space and execution of a function in the secure space being performed via the computer, the program causing the computer to perform: processing of determining a right in a region in the secure space on the basis of a policy disposed in the secure space and having defined therein at least one of an access right to the region in the secure space and an execution right of a function disposed in the region; and processing of controlling the access to and the execution in the secure space.

(Supplementary note 13) The right determination program according to supplementary note 12, wherein the policy has defined therein at least one of graded access rights for respective regions in the secure space and graded execution rights for respective functions disposed in the regions.

### Reference Signs List

10 device

20 memory space

30 non-secure space

40 secure space

41 policy storage unit

42 determination device

43 bus

100 right determination system

1. A right determination system comprising:
a device including a memory space having a secure space;
a determination device disposed in the secure space and configured to determine a right in a region in the secure space; and
a policy storage unit disposed in the secure space and storing a policy having defined therein at least one of an access right to the region and an execution right of a function disposed in the region; wherein
access to the secure space and execution of the function in the secure space are performed via the determination device, and
the determination device controls the access to and the execution in the secure space on the basis of the policy.

2. The right determination system according to claim 1, wherein the policy storage unit stores the policy having defined therein at least one of graded access rights for respective regions in the secure space and graded execution rights for respective functions disposed in the regions.

3. The right determination system according to claim 1, wherein the secure space has a tamper resistance, and the determination device has a highest right set in the secure space having the tamper resistance.

4. The right determination system according to claim 1, wherein the determination device performs, in accordance with the right indicated by a determination result, reading from a region in the secure space, writing to the region, or execution of a code or program held in the region.

5. The right determination system according to claim 1, wherein
the memory space has a plurality of secure spaces, and
the determination device is disposed in any one of the plurality of secure spaces.

6. A secure device including a memory space having a secure space, the secure device comprising:
a determination device disposed in the secure space and configured to determine a right in a region in the secure space; and
a policy storage unit disposed in the secure space and storing a policy having defined therein at least one of an access right to the region and an execution right of a function disposed in the region; wherein
access to the secure space and execution of the function in the secure space are performed via the determination device, and
the determination device controls the access to and the execution in the secure space on the basis of the policy.

7. The secure device according to claim 6, wherein the policy storage unit stores the policy having defined therein at least one of graded access rights for respective regions in the secure space and graded execution rights for respective functions disposed in the regions.

8. A determination device disposed in a secure space in a memory space included in a device, wherein
access to the secure space and execution of a function in the secure space are performed via the determination device, and
the determination device determines a right in a region in the secure space on the basis of a policy disposed in the secure space and having defined therein at least one of an access right to the region in the secure space and an execution right of a function disposed in the region, and controls the access to and the execution in the secure space.

9. The determination device according to claim 8, wherein the policy has defined therein at least one of graded access rights for respective regions in the secure space and graded execution rights for respective functions disposed in the regions.

10. A right management method for a device including a memory space having a secure space, the method comprising:
controlling access to and execution in the secure space by a determination device on the basis of a policy, the determination device being disposed in the secure space and configured to determine a right in a region in the secure space, the policy being disposed in the secure space and having defined therein at least one of an access right to the region in the secure space and an execution right of a function disposed in the region, wherein
the access to the secure space and the execution of the function in the secure space are performed via the determination device.

11. The right management method according to claim 10, wherein the policy has defined therein at least one of graded access rights for respective regions in the secure space and graded execution rights for respective functions disposed in the regions.

12. A non-transitory computer readable information recording medium storing a right determination program applied to a computer disposed in a secure space in a memory space included in a device,
access to the secure space and execution of a function in the secure space being performed via the computer,
when executed by a processor, the program performs a method for:
determining a right in a region in the secure space on the basis of a policy disposed in the secure space and having defined therein at least one of an access right to the region in the secure space and an execution right of a function disposed in the region; and
controlling the access to and the execution in the secure space.

13. The non-transitory computer readable information recording medium according to claim 12, wherein the policy has defined therein at least one of graded access rights for respective regions in the secure space and graded execution rights for respective functions disposed in the regions.
